(19) United States
(12) Patent Application Publication
(10) Pub. No.: US 2013/0132138 A1
(43) Pub. Date: May 23, 2013

(54) IDENTIFYING INFLUENCE PATHS AND EXPERTISE NETWORK IN AN ENTERPRISE USING MEETING PROVENANCE DATA

(71) Applicants: Yurdaer N. Doganata, Chestnut Ridge, NY (US); Mercan Topkara, Thornwood, NY (US)

(72) Inventors: Yurdaer N. Doganata, Chestnut Ridge, NY (US); Mercan Topkara, Thornwood, NY (US)

(73) Assignee: International Business Machines Corporation, Armonk, NY (US)

(21) Appl. No.: 13/303,573

(22) Filed: Nov. 23, 2011

(51) Int. Cl. G06Q 10/06

(52) U.S. Cl. 705/7.11

(57) ABSTRACT

Techniques are disclosed for identifying influence paths and expertise networks in an enterprise using provenance data associated with one or more meetings. For example, a method for processing provenance data comprises the following steps: generating provenance data for each of one or more meetings that capture one or more aspects of each meeting, correlating the provenance data between the one or more meetings, identifying a main topic and one or more sub-topics of each of the one or more meetings to establish a relation between the one or more meetings on a basis of topic, and identifying a path of influence among one or more meetings based on the correlated provenance data and the topic relation of the one or more meetings, wherein a path of influence comprises a meeting that influences one or more subsequent meetings on a basis of provenance data and topic.

### FIELD OF THE INVENTION

Embodiments of the present invention relate to provenance data processing and, more particularly, to techniques for identifying influence paths and expertise networks in an enterprise using provenance data associated with one or more meetings.

### BACKGROUND OF THE INVENTION

Meetings are considered as one of the most important activity in a business environment. Many enterprises hold regular meetings as part of their routine operations. Delivering information, keeping each other updated, discussing issues around team projects, assigning tasks, tracking progress and making decisions are some of the reasons why meetings are a very important part of a professional and human activity. Recording meetings are as important as conducting them.

Members of an enterprise access past meeting records to recall details of a particular meeting or to catch up with others if they missed a meeting. People often refer to meeting records. The reasons include checking the consistency of statements and descriptions, revisiting the portions of a meeting which were missed or not understood, re-examining past positions in light of new information and obtaining supportive evidence.

Before the advancement of computer and communication technologies, a significant amount of time and effort was spent on producing written documents related to the meetings. Transforming meeting minutes into written documents manually suffers from a lack of accuracy, completeness and objectivity. The process of transforming meeting minutes into written documents puts a burden on the preparer who may not remember all the details or transcribe them correctly.

Advances in computer and communication technologies made networked multimedia meetings possible. Virtual meetings over the Internet by sharing desktop applications and whiteboards with the integration of text, audio and video capturing capabilities have become a popular way of conducting meetings among geographically dispersed users. Vast amounts of audio, visual and textual data are typically recorded and stored for such a virtual meeting.

One example of recorded meeting data is a so-called on-line meeting log. Such a log contains valuable information about how ideas are developed and spread within the enterprise, which presentations, meetings are significant, how people are linked, etc. The information can also be used to speed up the orientation of new employees and replacements within an enterprise.

### SUMMARY OF THE INVENTION

Illustrative embodiments of the invention provide techniques for identifying influence paths and expertise networks in an enterprise using provenance data associated with one or more meetings.

For example, in one embodiment, a method for processing provenance data comprises the following steps: generating provenance data for each of one or more meetings that capture one or more aspects of each meeting, correlating the provenance data between the one or more meetings, identifying a main topic and one or more sub-topics of each of the one or more meetings to establish a relation between the one or more meetings on a basis of topic, and identifying a path of influence among one or more meetings based on the correlated provenance data and the topic relation of the one or more meetings, wherein a path of influence comprises a meeting that influences one or more subsequent meetings on a basis of provenance data and topic.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a sample graph of evolution of discussed topics in various meetings, according to an embodiment of the invention.

FIG. 2 illustrates a system for identifying influence paths and expertise networks in an enterprise using provenance data associated with one or more meetings, according to an embodiment of the invention.

FIG. 3 illustrates a methodology for identifying influence paths and expertise networks in an enterprise using provenance data associated with one or more meetings, according to an embodiment of the invention.

FIG. 4 illustrates a video clip of a meeting, according to an embodiment of the invention.

FIG. 5 illustrates sample code for slides presented at a meeting, according to an embodiment of the invention.

FIG. 6 illustrates sample code for speech-to-text segments associated with a meeting, according to an embodiment of the invention.

FIG. 7 illustrates sample code for roles of participants at a meeting, according to an embodiment of the invention.

FIG. 8 illustrates a provenance graph representing a meeting, according to an embodiment of the invention.

FIG. 9 illustrates a database table representing provenance of a meeting, according to an embodiment of the invention.

FIG. 10 illustrates a database table of detected meeting topics and correlations, according to an embodiment of the invention.

FIG. 11 illustrates a database table of an expert network, according to an embodiment of the invention.

FIG. 12 illustrates a computing system in accordance with which one or more components/steps of the techniques of the invention may be implemented, according to an embodiment of the invention.

### DETAILED DESCRIPTION OF PREFERRED EMBODIMENTS

Illustrative embodiments of the invention may be described herein in the context of virtual meetings associated with a given organization or business. However, it is to be understood that techniques of the invention are not limited to virtual meeting applications associated with an organization or business but are more broadly applicable to any meetings associated with any enterprise or enterprises.

As used herein, the term “enterprise” is understood to broadly refer to any entity that is created or formed to achieve some purpose, examples of which include, but are not limited to, an undertaking, an endeavor, a venture, a business, a concern, a corporation, an establishment, a firm, an organization, or the like. Further, a meeting associated with such an enterprise may involve one or more individuals.

As used herein, the term “provenance” is understood to broadly refer to an indication or determination of where something, such as a unit of data, came from or an indication or determination of what it was derived from. That is, the term “provenance” refers to the history or lineage of a particular item. Thus, “provenance information” or “provenance data” is information or data that provides this indication or results of such determination.

As used herein, the term “meeting” is understood to broadly refer to a coming together or gathering of persons and/or entities in a physical sense and/or a virtual sense (i.e., via computing devices connected via a network).

As used herein, the term “artifacts” is understood to broadly refer to one or more items (tangible and intangible), persons and byproducts of a meeting.

It is to be appreciated that techniques of the invention may be used in conjunction with the techniques for automatic discovery of enterprise process information described in pending U.S. patent application Ser. No. 12/265,975, filed Nov. 6, 2008, entitled “Processing of Provenance Data for Automatic Discovery of Enterprise Process Information,” the disclosure of which is incorporated by reference herein.

Also, it is to be understood that techniques of the invention may be used in conjunction with the meeting history management techniques described in pending U.S. patent application Ser. No. 12/826,919, filed Jun. 30, 2010, entitled “Management of a History of a Meeting,” the disclosure of which is incorporated by reference herein.

It is realized that building an “expertise network” for an organization is important to improve employees' success as well as to improve an organization's overall efficiency. An “expertise network,” as used herein, is understood to broadly refer to a representation that conveys interactions between individuals and/or groups in a given organization (or even outside the organization). For example, it is known that an expertise network may be constructed based on email and instant message communications. Using such a representation as an expertise network, one may be able to discover expertise in his/her own organization.

However, it is realized herein that additional techniques are needed to utilize the information hidden in such data items as meeting logs, which contain social and influential analytics information that cannot be extracted from instant messages or emails. In addition, it is realized herein that there is a need for techniques to identify influence paths in expertise networks by connecting keywords, “spinoff” ideas from the main stream discussions, etc. As will be explained herein below, embodiments of the invention address these needs and overcome the shortcomings of existing expertise network construction approaches.

Additionally, some meetings influence the scope of future meetings. This can be the case, for example, when the topics discussed in a meeting possibly inspire new or modified ideas and, as a result, new meetings are scheduled and/or held about the ideas initiated in the prior/original meeting. Accordingly, as described and used herein, if a topic discussed in a meeting is influenced by the topics discussed in a prior meeting, the later is said to be on the influence path of the former. There can be, for example, more than two meetings on the influence path of a meeting. The influence of a meeting over another meeting may be measured, by way of example, by the same or related slides presented or the same participants participating in the meetings, as well as by the similarities between the words that represent the topic discussed in the meetings.

As will be explained in illustrative detail herein, embodiments of the invention provide a global view of the influence and expertise of workers in an organization through generating a provenance graph that can display a history of how ideas and projects formed and progressed. An exemplary result of the inventive techniques includes a temporal graph of topics discussed over all meetings held in an organization and the life cycle of ideas and projects and the participants who were effective in their generation and their influence paths. In one or more illustrative embodiments, analysis is based on what was discussed during the meeting and who attended the meeting.

Furthermore, one or more illustrative embodiments extract insight from meeting flows and enable easy access to various meeting information and artifacts stored in a meeting provenance structure such as a provenance graph. The extracted information includes detailed participant involvement such as who presented, what and when; who participated and how long; the speech-to-text captions and their analysis. Cross analysis of different meetings and presentations are used to answer questions such as: When was a topic first mentioned? Who first coined a specific phrase? How did a topic get propagated? What is the lineage of a topic? Correlation between meeting participants and topics are used to measure the influence of individuals/groups in developing and shaping ideas as well as the significance of a meeting.

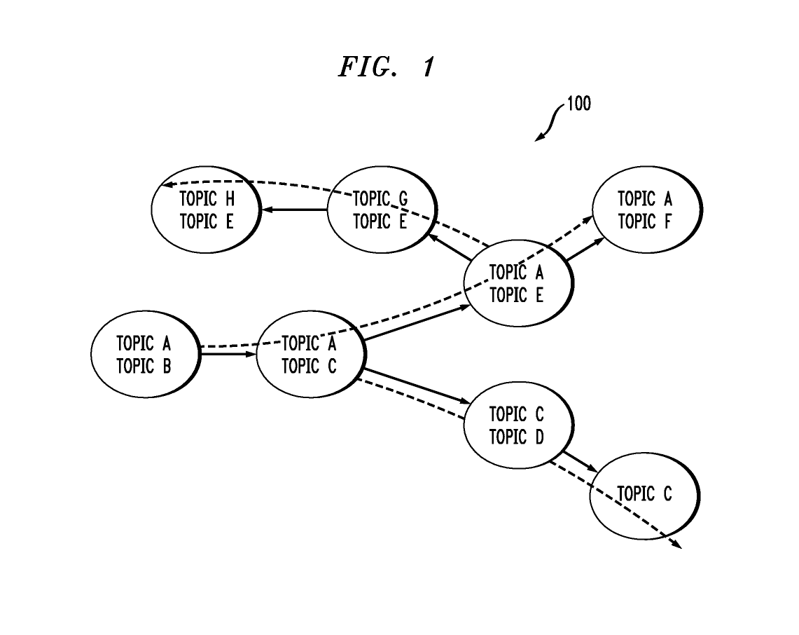

FIG. 1 shows a sample graph of evolution of discussed topics in various meetings. Each node in the graph 100 represents a meeting, and topics are detected through the use of natural language data analysis on the recorded meeting artifacts. Meetings are linked via common attendees on these meetings. In the conceptual visualization of FIG. 1, the arrows show the time in progress and each circle represents a meeting. The meetings are labeled with the topics discussed during the meeting, and the connections between two meetings show that there is at least one participant and one topic common in both meetings.

In addition to finding influence paths, one or more illustrative embodiments of the invention derive significance measures for the meetings. These significance measures may include, for example, a measure of the importance of a chart based on the number and the rank of the people who are exposed to the chart and the number of times the chart is presented at a meeting. A measure of importance of a meeting can be determined based on the attendance rate (i.e., more attendees means higher significance measure, while less attendees means lower significance measure).

Other organizational benefits that flow from one or more embodiments of the invention include making the meeting information available for a new employee for fast orientation and knowledge transfer.

In the description of illustrative embodiments below, it is assumed that a meeting provenance graph is generated in accordance with the above-referenced U.S. patent application Ser. No. 12/826,919, filed Jun. 30, 2010, and entitled “Management of a History of a Meeting.”

Such as meeting provenance graph may capture the important meeting artifacts and relations among them. The meeting artifacts may include, but are not limited to, participants, presenters, slides, speech-to-text captions and actions of the meeting participants, as well as presentations, discussions, audio and video clips, meeting agenda and other related data captured during the meeting. A database table can be created from the artifacts where the rows of the table are populated by the attributes of each artifact.

It is realized herein that a meeting can be modeled as a set of activities executed by various actors such as a process where textual and audio visual data are consumed or produced at different steps. In effect, a meeting is a process with a start event and an end event and a sequence of other events in between. Hence, provenance graphs may be generated for meetings applications. In a meeting provenance graph, meeting activities, data and participants are represented as nodes and causal relations are represented as edges. Since the graph contains information about the history of a meeting, related questions can be answered through a graph query interface.

Visualization of a meeting as a graph gives the users a better insight about the meeting flow, involvement of different participants and access to various meeting information simply by clicking on the corresponding icons in the graph. In the absence of visualization, without the meeting context, users do not have anchors for navigating artifacts of a meeting recording. Traditional multimodal search of meeting logs return lists of results against keywords. Provenance graph queries, on the other hand, render the results in connection with other artifacts.

That is, one or more illustrative embodiments of the invention archive meeting records in the form of a graph in a database and attributes of each artifact are extracted from the database through a query interface.

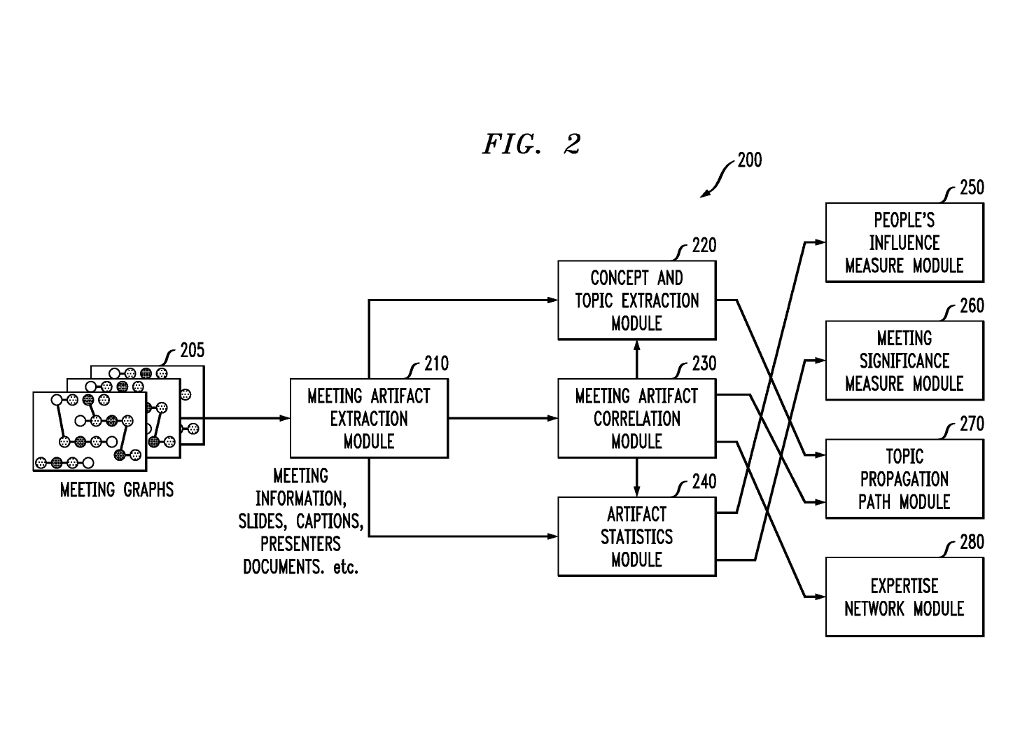

FIG. 2 shows an illustrative architecture of the inventive system. More particularly, FIG. 2 illustrates a system 200 for identifying influence paths and expertise networks in an enterprise using provenance data associated with one or more meetings, according to an embodiment of the invention.

As shown, the system comprises a meeting artifact extraction module 210 coupled to a concept and topic extraction module 220, a meeting artifact correlation module 230 and an artifact statistics module 240. The artifact statistics module 240 is coupled to a people's influence measure module 250 and a meeting significance measure module 260. The meeting artifact correlation module 130 is coupled to a topic propagation path module 270 and an expertise network module 280. The meeting artifact correlation module 230 is also coupled to the concept and topic extraction module 220 and the artifacts statistics module 240. The concept and topic extraction module 220 is coupled to the topic propagation path module 270.

The concept and topic extraction process carried out via module 220 is realized by vector representation of topics or concepts. A topic is represented by a vector of the form [s1, s2, . . . sM], where the elements of the vector, s_i, are words. The feature vector of a meeting is constructed by performing text analysis over the caption text and by extracting keywords and concepts from the slides presented in a meeting. By clustering the feature vectors of potential topics, it is possible to detect the topics of a meeting. Also, feature vectors of similar topics form a cluster. The topics of a meeting are determined by comparing the feature vector of the meeting with labeled clusters of potential topics. Several topics can be assigned to one meeting with varying relevance scores. The label of the cluster which is closest to the feature vector of the meeting becomes the top ranking topic of that particular meeting.

The distance between two feature vectors is determined by using the concept of Euclidian distance. Module 220 in FIG. 2 performs this function. The captions of the presentations and conversations, as well as the content of slides contain valuable information about ideas, topics and decisions. Text analysis techniques are applied to detect named entities. Example text analysis techniques can include, for instance, Florian et al., A Statistical Model for Multilingual Entity Detection and Tracking, HLT, 2004, the disclosure of which is incorporated by reference herein. Detected named entities are associated with concepts by using semantic mapping techniques. Example semantic mapping techniques can include, for instance, Bellegarda, “Latent Semantic Mapping, Signal Processing Magazine,” IEEE 2005, the disclosure of which is incorporated by reference herein, as well as dictionaries and thesaurus. For each meeting, a main topic and sub-topics are detected by using topic detection techniques. Example topic detection techniques can include, for instance, D. Blei., “Introduction to Probabilistic Topic Models,” Communications of the ACM 2011, the disclosure of which is incorporated by reference herein.

The lineage of meeting artifacts are captured and stored in a database as one or more graphs 205. As explained above, one or more of the meeting graphs 205 can be a provenance graph as generated in accordance with techniques described in the above-referenced U.S. patent application Ser. No. 12/826,919, filed Jun. 30, 2010, and entitled “Management of a History of a Meeting.” However, it is to be appreciated that graphs 205 can be formed via other alternate mechanisms.

Meeting artifacts are extracted from the archived meetings via meeting artifact module 210 by using graph queries. The artifacts are represented as nodes and their relations are represented as edges in the graph. These will be explained in more detail below. The list of meeting artifacts may include, but is not limited to, meeting participants, shared content (e.g., slides), captions, other meeting resources, tasks and activities.

From the slides presented in the meetings and captions extracted out of recorded audio, topics and concepts are extracted via concept and topic extraction module 220.

The artifacts are correlated in meeting artifact correlation module 230 based on the participants, time stamps, topics discussed, and the commonly shared content (e.g., slides that are presented in several meetings). As an example, people who participate in the same meeting are correlated, the meetings that use the same slides and discussion over the same slides are correlated, etc. The correlations are stored as tables in module 230.

The statistics of artifacts are collected and utilized to find out how people are influencing the others and the importance of meetings in artifact statistic module 240. Correlations are used to find out how certain concepts are propagated from one meeting to another in topic propagation path module 270. This yields a topic propagation path that represents the connection of meetings (spanning over time) where the same topics were discussed. The topic path includes all the meetings where the same topic is discussed. A meeting can be on multiple topic paths.

Also, an expertise network is built from the people participating in the meetings around similar topics in expertise network module 280. A meeting significance measure and a people's influence measure are computed in modules 250 and 260, respectively.

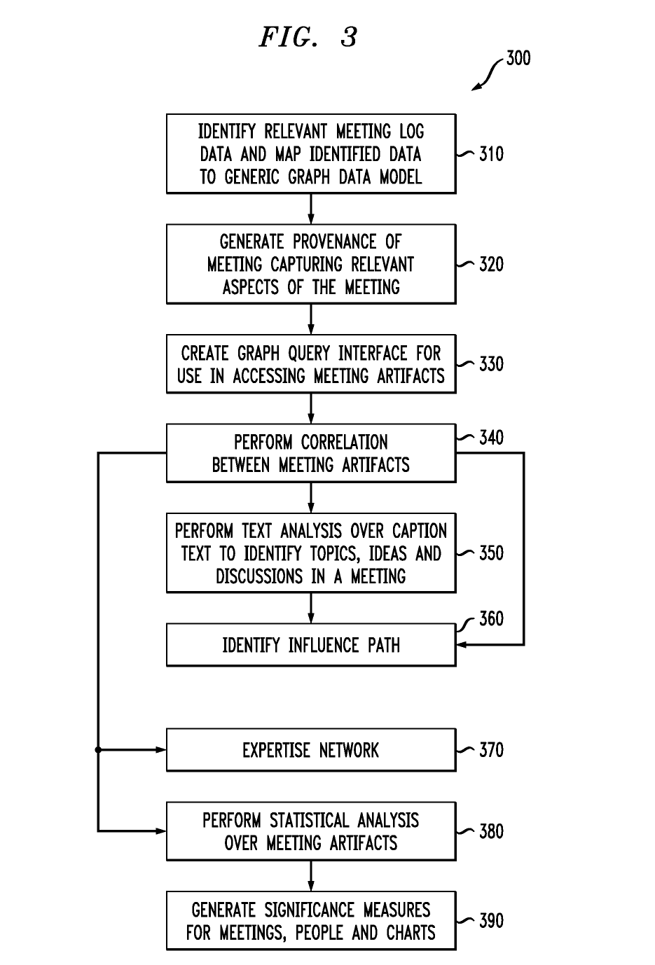

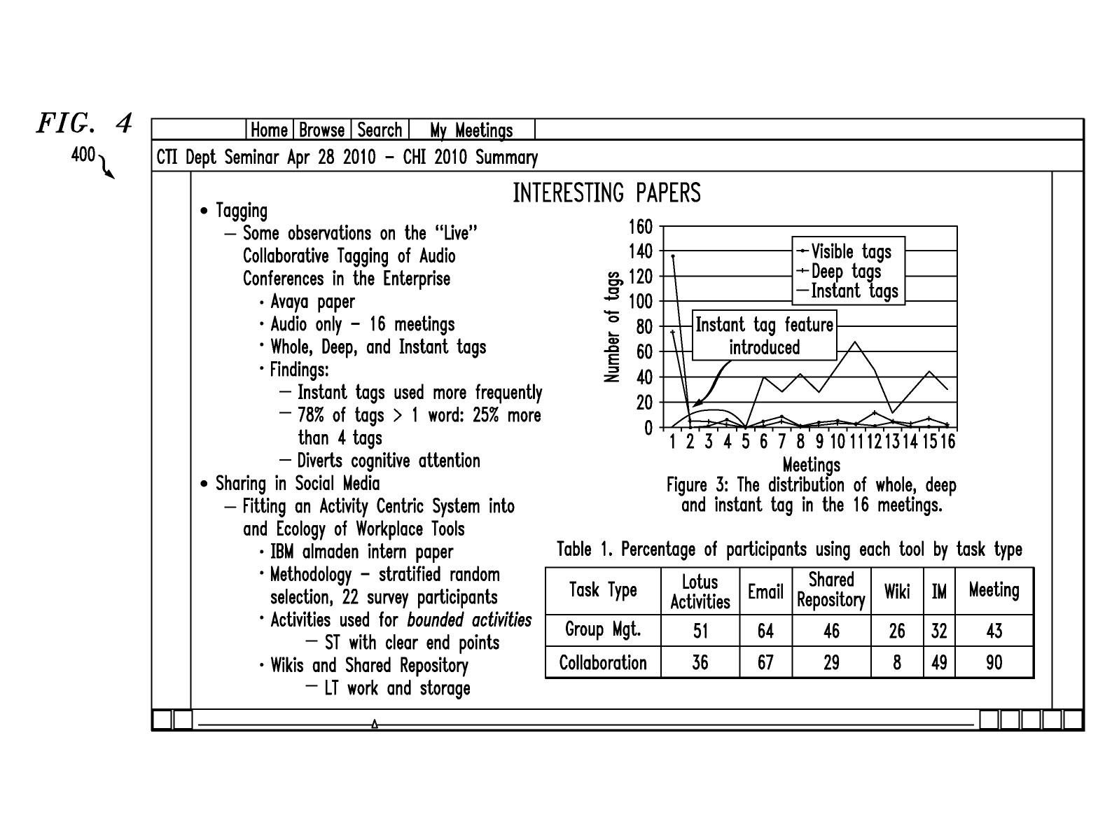

FIG. 3 illustrates a methodology for extracting meeting artifacts from a provenance meeting graph and identifying influence paths, expertise networks and significance measures for meetings.

The methodology 300 is based on analyzing meeting logs that are used to extract and correlate relevant meeting information. The steps of the methodology are as follows.

(1) Step 310 comprises identifying relevant meeting log data and mapping the extracted data to generic graph data model, where meeting artifacts are the nodes and the relations are the edges of the graph. In one aspect of the invention, module 205 depicted in FIG. 2 carries out this step.

Extracted meeting event data contains information about the meeting artifacts such as the slides presented, the roles of the people who were in the meeting, speech-to-text translation segments, etc. The first step of visualizing a meeting as a graph is to supply a data model for various classes of graph nodes and edges. Once the node and edge types are defined, then the raw meeting event data instances are mapped onto the graph types constituting the instances of graph nodes and edges.

Data Type: These are the artifacts that were produced, utilized or modified during the execution of a meeting. Typically, these are the presentation slides, audio or video clips, voice transcripts, chat messages and database records.

Task Type: A task record is the representation of a particular meeting activity. Usually, but not necessarily, meeting activities utilize or manipulate data and are executed by the meeting participants. Making a presentation, introducing participants, holding discussions, answering questions are various activities of a meeting.

Resource Type: A resource record represents a person, or any resource that is the actor of a particular task. Participants, presenters, meeting organizers are the resources of a meeting.

Relation Type: These records are generally produced as a result of correlating two records.

Meeting Type: A meeting record is used to connect the artifacts that belong to a particular meeting together.

Meeting artifacts of various types are detected by the recording probes which act as the event listeners of the underlying meeting systems. An overview of some of the existing online meeting applications and recording capabilities that may be employed herein can be found in online meeting system literature. Such details will not be described herein because it is assumed that a meeting log has been generated using an existing online meeting system.

In order to recreate a meeting end-to-end from the event data, the meeting artifacts of several types must be connected together. This naturally translates into creating edges in a meeting provenance graph by adding relation records which can be done in multiple steps. Basic relations between a task and the manipulated data or a task and the resources can be established based on the information that the task record holds.

As an example, presentation is one of the most common activities of a meeting. A particular presentation task starts when the presenter starts speaking and projecting the slides. As a result, the relations between the presentation task and the slides as well as the speaker are established automatically. More complex relations are discovered by running analytics and locating the correct provenance records in the provenance graph. Other relations are established by utilizing the data outside of provenance graph, such as the data stored in content repositories.

As new relations are added, the underlying provenance graph gets continuously enriched, as the creation of some relations may trigger execution of other enrichment rules. As relations between meeting records are established, the hyperlinked structure provides for each such record a context that describes its lineage with a path into related events that had occurred prior to its existence and related events that had happened later.

(2) Step 320 comprises generating the provenance of a meeting that captures all the relevant aspects of a meeting. In one aspect of the invention, module 205 depicted in FIG. 2 carries out this step.

In order explain how to generate the provenance of a meeting, the recordings of an existing online department meeting can be used as an example. The sample meeting is recorded by using a Collaborative Recorded Meetings application (see, for example, Topkara et al., “Tag Me While You Can: Making Online Recorded Meetings Shareable and Searchable, IBM Research Report, 2010, the disclosure of which is incorporated by reference herein). During the meeting, some of the participants share their impressions about a CHI 2010 conference with the group members after they come back from the conference. A video clip 400 of this meeting, as shown in FIG. 4, and some raw event data files in XML (Extensible Markup Language) format are available for extracting meeting artifacts.

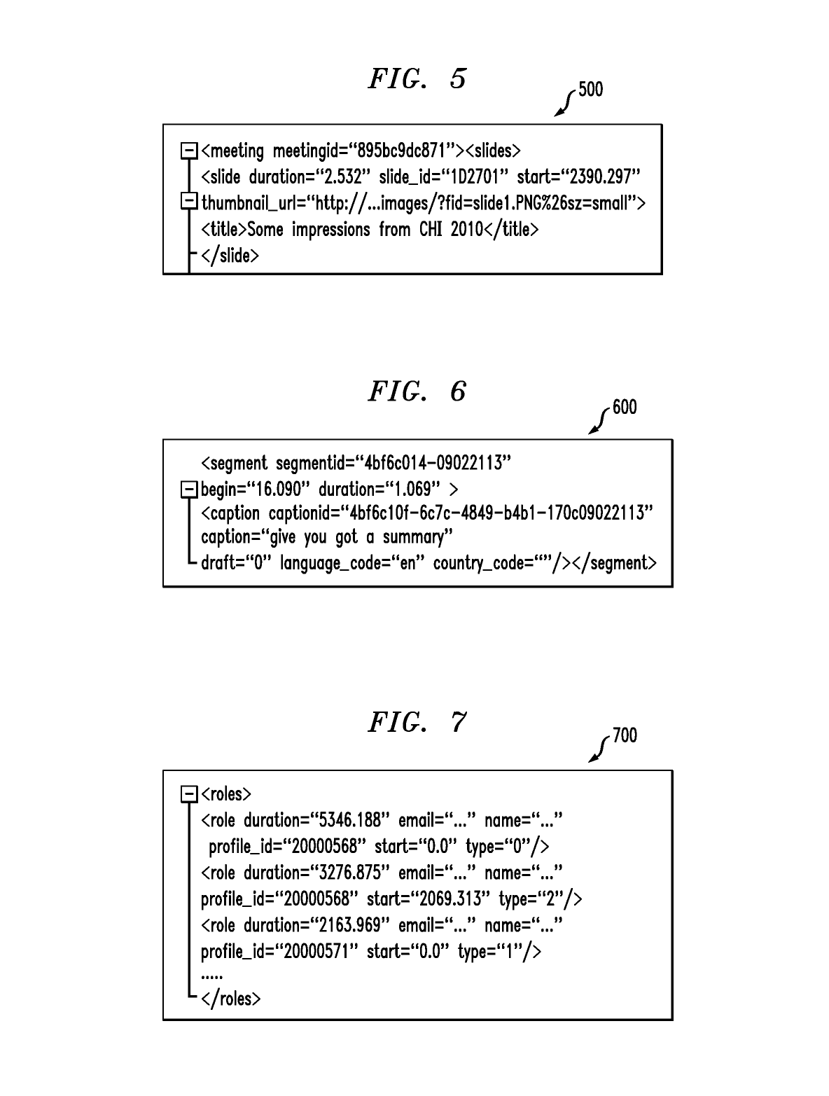

So, the starting point is the raw XML files that contain information about the slides presented, the roles of the people who were in the meeting, speech-to-text translation segments and information about the meeting itself. FIG. 5 shows sample XML code (file) 500 that is executed to extract meeting information, in this case, slides presented at the meeting. FIG. 6 shows sample XML code (file) 600 that is executed to extract speech-to-text segments from the meeting including their durations and starting points. FIG. 7 shows sample XML code (file) 700 that is executed to extract participants and their roles at the meeting.

As a result of extracting meeting artifacts from event data and mapping them onto the data model, the following graph node types are generated:

DataType: segmentType: Speech-to-text captions

TaskType: presentationType: Slide presentations

ResourceType: rolesType: Participants

In addition, relation records are created between slides, the presenter of the slides, participants and the speech-to-text captions by using the time and duration information associated with each artifact. This way, a slide presentation and the associated speech-to-text caption are connected to the correct presenter and the presentation.

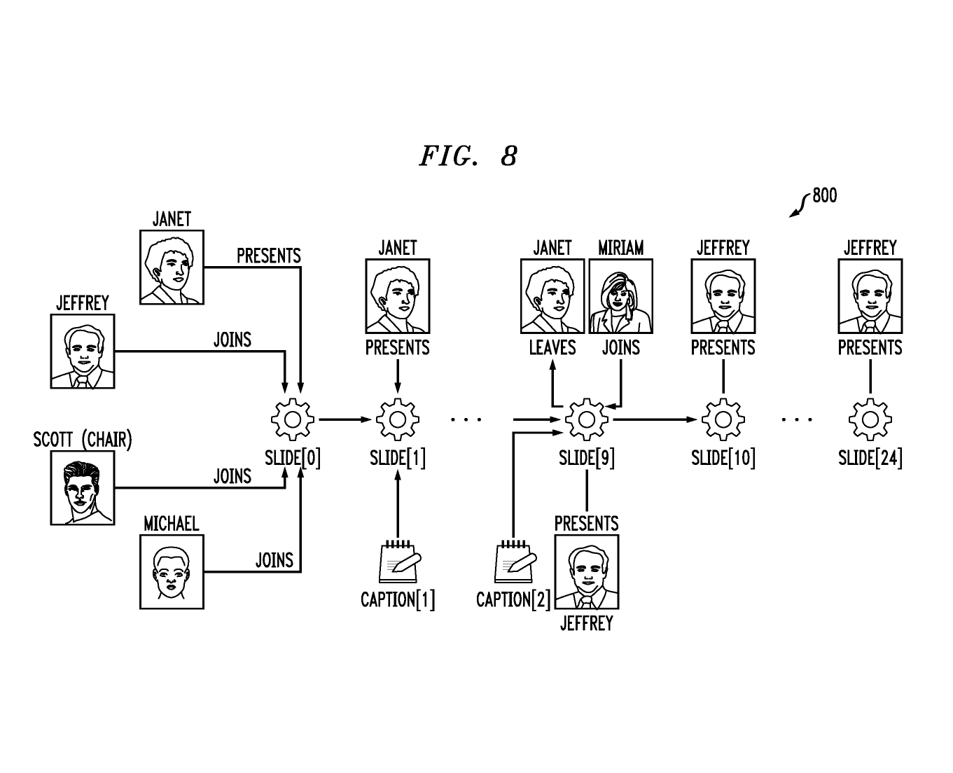

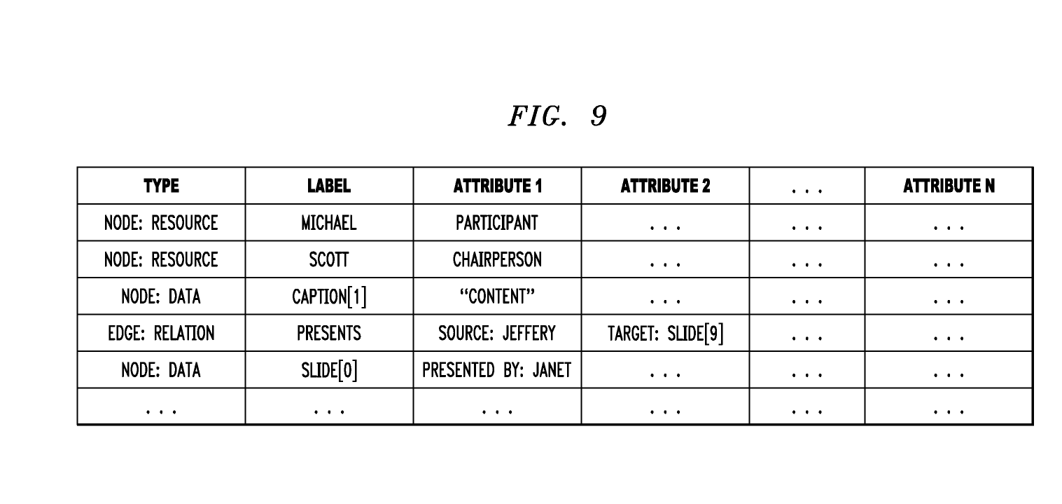

FIG. 8 depicts a visualization of a meeting graph (a provenance graph) 800 where Janet, Scott, Jeffrey, Michael and Miriam are resource nodes, speech-to-text captions are data nodes and the slide presentations are the task nodes.

Recall that visualization of the meeting graph (a provenance graph) is explained in the above-referenced U.S. patent application Ser. No. 12/826,919. Note that there is a task node corresponding to presentation of each slide. Each slide presentation task is connected to the prior and the next presentation slides, keeping the flow in order. The role of each participant is also displayed as an edge in the graph.

The graph immediately reveals information about the meeting that is not visible from meeting records such as the fact that Miriam was not present when the meeting started. As shown, she joined the meeting during Jeffrey's presentation of the 9^{th} slide. Janet, on the other hand, left the meeting during Jeffrey's presentation. 24 slides were presented in the meeting. These are some indications of how the visibility of meeting information is increased through graph visualization. It is evident from the graph 800 displayed in FIG. 8 that Janet started the presentation with slide[0] to Jeffrey, Scott and Michael. Scot is the chair of this meeting. Janet's presentation lasted until the ninth slide after which Janet left and Miriam joined. Jeffrey is the second presenter who presented slide[9] to slide[24].

(3) Step 330 comprises creating a graph query interface to enable easy access to meeting artifacts.

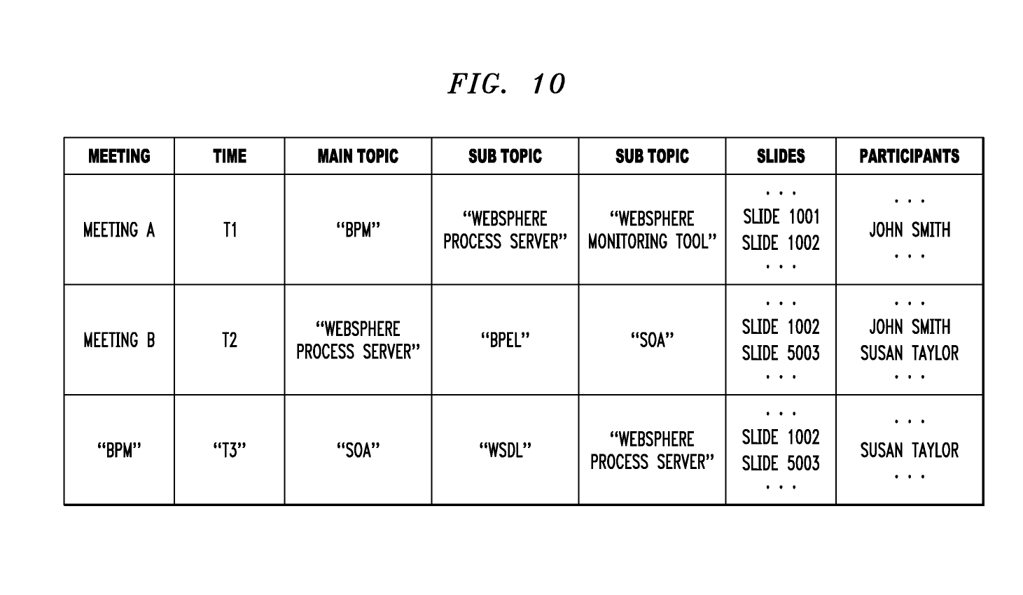

The provenance of the meeting, represented as a graph in FIG. 8, can also be represented as a database table with rows and columns where the rows are nodes and edges, and the columns are the attributes of these artifacts. FIG. 9 shows one such example. Each row represents a meeting artifact. The graph type of an artifact is either a node or an edge. Once a database table is produced from the graph, meeting artifacts, their relations and the attributes are accessed via any existing database query interface (such as, for example, structured query language (SQL) and DB2).

(4) Step 340 comprises performing correlation between meeting artifacts. As a result of this, meeting artifacts such as slides, captions, presenters, participants and their relations among themselves and to the meeting are identified. As an example, step 340 provides the links between participants and the meetings, between slides and the presenters, or slides and the meetings. This function is realized by module 230 in FIG. 2.

(5) Step 350 comprises finding the main topic and the sub-topics of a meeting as described in module 220 of FIG. 2 by using text analysis and feature vector clustering techniques. As a result of this step, a new relation is discovered between the meeting artifacts, namely the relationship between topics and meetings. Hence, at least one topic is associated with every meeting.

(6) Step 360 comprises identifying the meetings that influence each other that enable identification of a path of influence. In order to place two meetings on the influence path of a topic, a set of conditions must hold. One example embodiment for such conditions is given below:
(1) The topic of the path must be included in the list of the topics discussed in the meetings that are placed on the path.
(2) The meeting on the path must share at least one participant or presentation slide.

Hence, meetings are placed on the same path of influence based on, for example, the presentation slides used in the meeting, participants and the common topics.

The main and sub-topics of a meeting are identified by generating meeting feature vector through keywords obtained from captions, slides, and titles and comparing the distance of the feature vector to the labeled topic clusters as described in module 220 of FIG. 2. A sub-topic in a meeting may become the main topic in another meeting in the future, which may indicate an influence path. The shared participants and slides between meetings can be obtained via module 230 of FIG. 2. Information about the shared participants and slides are obtained via step 340 as a result of correlating participant and presentation information with the meetings, and are then used in step 360. Hence, through topic detection and cross meeting correlation, the influence path is determined.

If a topic has not appeared in the past meetings, the meeting is said to initialize the topic. Also, by way of example, if a topic is initialized by Meeting A and appears in the topics of a meeting, say Meeting B, in the future, then Meeting A is said to influence Meeting B provided that meetings A and B share a participant or a slide. All of the meetings that contain a particular topic initialized by Meeting A and shared a participant or a slide is said to be on the “influence path” of Meeting A.

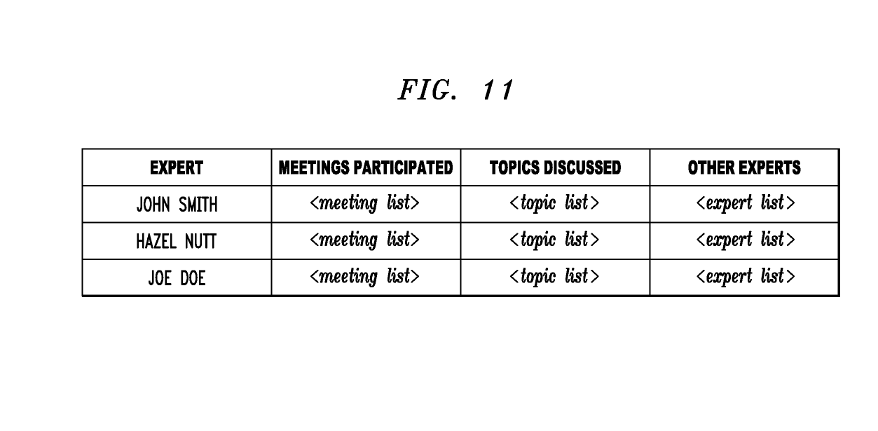

Detected meeting topics for sample meetings, their associated meeting times, presented slides and the list of participants are stored in a database table, as shown in FIG. 10. This databases table is constructed with the information retrieved from step 340 and step 350 (of FIG. 3). In the example depicted by FIG. 10, Meeting A and B can be placed on the same path of influence because they share the same topic which is “Websphere Process Server,” they have a common presentation slide 1002 and also John Smith is a participant in both meetings.

In this example, the path of influence is found as “Meeting A→Meeting B→Meeting C.” As a result of comparing the feature vector of Meeting A with labeled clusters, the label of the closest cluster is found as “BPM,” which is the “main topic.” Other spin-off topics are found by comparing the distances of the feature vector to other clusters of topics. One of the sub-topics of Meeting A is “Web Process Server,” and it is also the main topic of another meeting, Meeting B, which occurred on a later date T2>T1. In addition, John Smith is a participant in both meetings which share a slide, slide 1002. Hence, Meeting B is influenced by Meeting A. Following the same argument, one can conclude that Meeting C is also on the propagation path of the same topic, because Meeting B and C share a slide and the topic.

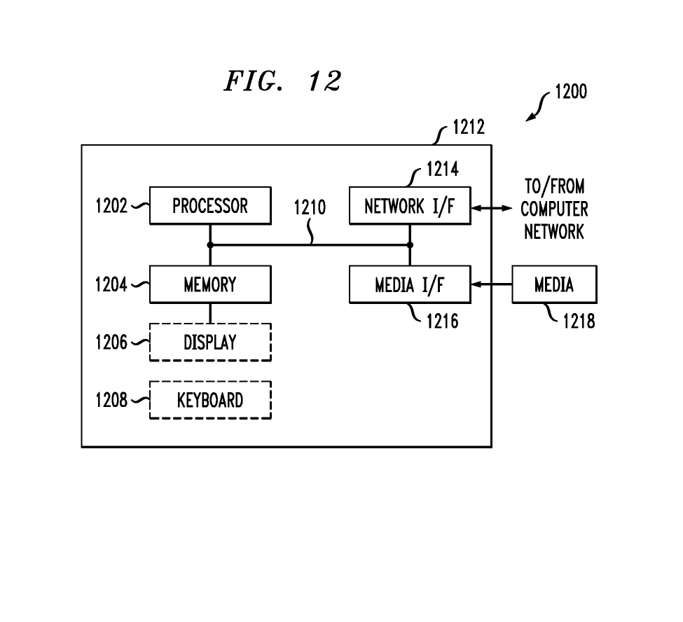

(6) Step 370 comprises building an expertise network by extracting topic and participant relations and linking people who use shared meeting data. An example of this step is shown in FIG. 11, where a database table is constructed with each row containing information related to a participant. The first column of the table identifies the participant, the second column is the list of meetings the participant participated, and the third column is the collection of the topics discussed in the meetings participated. The forth column is the list of the people who participated in meetings where similar topics were discussed. The fourth column labeled “Other Experts” can be constructed by retrieving and comparing the topics from the third column about which each participant is assumed to be knowledgeable. If the fields in the third column for two experts are overlapping, then the experts are connected by using the overlapping topics.

(7) Step 390 comprises defining significance measures for meetings, content shared during meetings (e.g., charts), content generators for meetings (e.g., people) using several factors and statistical information generated in step 380. For example, for a given chart, we can use the following statistics to calculate a significance (influence) measure:

(a) number of times a chart is presented;

(b) number of people who were exposed to a presentation;

(c) rank of people who were exposed to a presentation; and

(d) attendance rate in the meetings that these charts were presented.

By way of example:

Significance of Slide[N]=m1+m2+influence factor

where m1 is the number of meetings in which Slide[N] is presented, m2 is the total number of unique participants who attended the meetings when Slide[N] is presented. The influence factor is the weighted average of people based on their ranks. An executive level rank factor would be higher than a regular employee level rank. A simple formula for rank factor could be as follows:

Influence factor: c0*m20+c1*m21+c2*m22+c3*m23

where m20 is the number of regular employees, m21 is the number of first line managers, m22 is the number of second line managers, and m23 is the number of executives exposed to a particular slide or who attended a particular meeting. The weights c0, c1, c2 and c3 can be adjusted by each organization depending on how influence of workers of an organization is distributed.

Meeting significance measures can also be calculated by using a similar approach.

The influence of a person can be formulated as the weighted sum of the meetings participated in based on their significance, average of influence of the co-participants in the meetings, presentations made and slides created by that person, number of new topics spun off from the meetings this person has attended.

By way of example, the influence of Joe Doe has several components. The first one as the initiator of topics discussed and creator of shared content (e.g., slides), the second one as the presenter of a shared content (not necessarily created by him) and the third one as the participant of a meeting.

The first component of influence for Joe Doe can be calculated as the sum of all slides he created weighted by their influence factor plus the number of times he introduced a new term that later became a significant topic (this can be calculated using the speech transcript). The second component of influence, on the other hand, can be calculated as the sum of all slides Joe Doe has presented (but not created) weighted by influence factor. Finally, the third factor is the weighted sum of participated meetings.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1-11, the diagrams in the figures illustrate the architecture, functionality, and operation of possible implementations of systems, methods and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-11, can also include, as described herein, providing a system, wherein the system includes distinct modules (e.g., modules comprising software, hardware or software and hardware). By way of example only, the modules may include, but are not limited to, the various modules shown and described in the context of FIG. 2. These and other modules may be configured, for example, to perform the steps described and illustrated in the context of FIGS. 1-11.

One or more embodiments can make use of software running on a general purpose computer or workstation. With reference to FIG. 12, such an implementation 1200 employs, for example, a processor 1202, a memory 1204, and an input/output interface formed, for example, by a display 1206 and a keyboard 1208. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer).

The processor 1202, memory 1204, and input/output interface such as display 1206 and keyboard 1208 can be interconnected, for example, via bus 1210 as part of a data processing unit 1212. Suitable interconnections, for example, via bus 1210, can also be provided to a network interface 1214, such as a network card, which can be provided to interface with a computer network, and to a media interface 1216, such as a diskette or CD-ROM drive, which can be provided to interface with media 1218.

A data processing system suitable for storing and/or executing program code can include at least one processor 1202 coupled directly or indirectly to memory elements 1204 through a system bus 1210. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 1208 for making data entries; display 1206 for viewing provenance graph and data; pointing device for selecting data; and the like) can be coupled to the system either directly (such as via bus 910) or through intervening I/O controllers (omitted for clarity).

Network adapters such as network interface 1214 may also be coupled to the system to enable the data processing system to become coupled to other data processing systems or remote printers or storage devices through intervening private or public networks. Modems, cable modem and Ethernet cards are just a few of the currently available types of network adapters.

As used herein, a “server” includes a physical data processing system (for example, system 1212 as shown in FIG. 12) running a server program. It will be understood that such a physical server may or may not include a display and keyboard. Further, it is to be understood that the components shown in FIG. 2 may be implemented on one server or on more than one server.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method for identifying a path of influence among one or more meetings, the method comprising:
generating provenance data for each of one or more meetings that capture one or more aspects of each meeting;
correlating the provenance data between the one or more meetings;
identifying a main topic and one or more sub-topics of each of the one or more meetings to establish a relation between the one or more meetings on a basis of topic; and
identifying a path of influence among one or more meetings based on the correlated provenance data and the topic relation of the one or more meetings, wherein a path of influence comprises a meeting that influences one or more subsequent meetings on a basis of provenance data and topic, wherein one or more steps of the method are performed by a computer system comprising a memory and at least one processor coupled to the memory.

2. The method of claim 1, further comprising building an expertise network by extracting topic and participant relations and linking one or more participants who use shared meeting data.

3. The method of claim 1, wherein the provenance data comprises an extensible markup language file that contains information about one or more slides presented at a meeting.

4. The method of claim 1, wherein the provenance data comprises an extensible markup language file that contains information about a role of one or more people who were in a meeting.

5. The method of claim 1, wherein the provenance data comprises an extensible markup language file that contains information about a speech-to-text translation segment from a meeting.

6. The method of claim 1, wherein correlating the provenance data between the one or more meetings comprises providing a link between at least one of a participant and the one or more meetings, a slide and a presenter, and a slide and the one or more meetings.

7. The method of claim 1, wherein identifying a main topic and one or more sub-topics of each of the one or more meetings comprises using text analysis and a feature vector clustering technique.

8. The method of claim 1, wherein at least one topic is associated with every meeting.

9. The method of claim 1, wherein the main and the one or more sub-topics of a meeting are identified by generating a meeting feature vector through one or more keywords obtained from at least one of a caption, a slide, and a title, and comparing distance of the feature vector to one or more labeled topic clusters.

10. The method of claim 1, further comprising identifying meeting log data and mapping the log data to a generic graph data model, wherein meeting provenance data are nodes and one or more correlations are edges of the graph.

11. The method of claim 1, further comprising creating a graph query interface to enable access to meeting provenance data.

12. The method of claim 11, wherein the graph query interface comprises a database table.

13. The method of claim 1, further comprising storing one or more meeting main topics and sub-topics in a database table.

14. The method of claim 1, further comprising defining one or more significance measures for at least one of a meeting, content shared during a meeting, and a content generator for a meeting.

15. The method of claim 14, wherein defining one or more significance measures comprises using statistics including at least one of a number of times a chart is presented at a meeting, a number of people exposed to a presentation, a rank of people exposed to a presentation, and an attendance rate at a presentation.

16. An apparatus for identifying a path of influence among one or more meetings, the apparatus comprising:
a memory; and
a processor operatively coupled to the memory and configured to:
generate provenance data for each of one or more meetings that capture one or more aspects of each meeting;
correlate the provenance data between the one or more meetings;
identify a main topic and one or more sub-topics of each of the one or more meetings to establish a relation between the one or more meetings on a basis of topic; and
identify a path of influence among one or more meetings based on the correlated provenance data and the topic relation of the one or more meetings, wherein a path of influence comprises a meeting that influences one or more subsequent meetings on a basis of provenance data and topic.

17. The apparatus of claim 16, wherein the processor is further configured to build an expertise network by extracting topic and participant relations and linking one or more participants who use shared meeting data.

18. The apparatus of claim 16, wherein correlating the provenance data between the one or more meetings comprises providing a link between at least one of a participant and the one or more meetings, a slide and a presenter, and a slide and the one or more meetings.

19. The apparatus of claim 16, wherein identifying a main topic and one or more sub-topics of each of the one or more meetings comprises using text analysis and a feature vector clustering technique.

20. The apparatus of claim 16, wherein the main and the one or more sub-topics of a meeting are identified by generating a meeting feature vector through one or more keywords obtained from at least one of a caption, a slide, and a title, and comparing distance of the feature vector to one or more labeled topic clusters.

21. The apparatus of claim 16, wherein the processor is further configured to identify meeting log data and map the log data to a generic graph data model, wherein meeting provenance data are nodes and one or more correlations are edges of the graph.

22. The apparatus of claim 16, further comprising creating a graph query interface to enable access to meeting provenance data.

23. The apparatus of claim 16, wherein the processor is further configured to define one or more significance measures for at least one of a meeting, content shared during a meeting, and a content generator for a meeting.

24. The apparatus of claim 23, wherein defining one or more significance measures comprises using statistics including at least one of a number of times a chart is presented at a meeting, a number of people exposed to a presentation, a rank of people exposed to a presentation, and an attendance rate at a presentation.

25. An article of manufacture for identifying a path of influence among one or more meetings, the article of manufacture comprising a computer readable storage medium having tangibly embodied thereon computer readable program code which, when executed, causes a computer to:
generate provenance data for each of one or more meetings that capture one or more aspects of each meeting;
correlate the provenance data between the one or more meetings;
identify a main topic and one or more sub-topics of each of the one or more meetings to establish a relation between the one or more meetings on a basis of topic; and
identify a path of influence among one or more meetings based on the correlated provenance data and the topic relation of the one or more meetings, wherein a path of influence comprises a meeting that influences one or more subsequent meetings on a basis of provenance data and topic.
